(19) United States
(12) Patent Application Publication
(10) Pub. No.: US 2026/0213597 A1
(43) Pub. Date: Jul. 23, 2026

(54) COOLING STRUCTURE OF ELECTRIC MOTOR

(71) Applicant: SUBARU CORPORATION, Tokyo (JP)

(72) Inventor: Ryotaro KIMURA, Tokyo (JP)

(73) Assignee: SUBARU CORPORATION, Tokyo (JP)

(21) Appl. No.: 19/436,300

(22) Filed: Dec. 30, 2025

(30) Foreign Application Priority Data
Jan. 17, 2025 (JP) 2025-006858

(51) Int. Cl. H02K 1/32; H02K 1/20

(52) U.S. Cl. CPC H02K 1/32; H02K 1/20

(57) ABSTRACT

A cooling structure of an electric motor includes a rotor core and a stator core. The rotor core includes stacked electromagnetic steel sheets. The stator core includes stacked electromagnetic steel sheets. Recessed grooves that allow a cooling medium to flow through the recessed grooves are provided substantially radially in each of the electromagnetic steel sheets constituting the rotor core and/or the electromagnetic steel sheets constituting the stator core.

### CROSS-REFERENCE TO RELATED APPLICATIONS

The present application claims priority from Japanese Patent Application No. 2025-006858 filed on Jan. 17, 2025, the entire contents of which are hereby incorporated by reference.

### BACKGROUND

The present disclosure relates to a cooling structure of an electric motor.

In recent years, a hybrid vehicle (HEV) that can effectively improve a fuel consumption rate (fuel consumption) of a vehicle by using an engine and an electric motor in combination has been widely put into practical use. In addition, an electric vehicle (BEV) that uses only an electric motor as a power source and does not discharge exhaust gas has also been put into practical use.

In such hybrid vehicles and electric vehicles, for example, a compact and highly efficient permanent magnet synchronous motor (PM synchronous motor) or the like is suitably used.

The permanent magnet synchronous motor is a rotating field type electric motor in which a permanent magnet is incorporated in a rotor and an armature winding (stator winding) is provided in a stator.

Incidentally, for example, in order to increase the output of the electric motor, it is desired to improve the cooling performance to cope with an increase in the amount of heat generation accompanying the improvement in the output. Here, for example, Japanese Unexamined Patent Application Publication (JP-A) No. 2013-183481 discloses a cooling structure of a rotor for a rotary electrical machine capable of efficiently cooling a central region in an axial direction of a rotor core and making cooling performance for the rotor core uniform in the axial direction.

For example, the cooling structure of the rotor for a rotary electrical machine includes a rotor core including stacked magnetic plate materials in the axial direction of the rotary electrical machine and provided with a refrigerant flow path hole for allowing a coolant to flow in the axial direction of the rotary electrical machine. The cooling structure is configured such that the coolant flowing out from a shaft is supplied to a central region in the axial direction of the rotor core through an inner diameter side of the refrigerant flow path hole, and flows into the refrigerant flow path hole in the central region to flow to both axial sides of the rotor core.

### SUMMARY

An aspect of the disclosure provides a cooling structure of an electric motor. The cooling structure of the electric motor includes a rotor core and a stator core. The rotor core includes stacked electromagnetic steel sheets. The stator core includes stacked electromagnetic steel sheets. Recessed grooves that allow a cooling medium to flow through the recessed grooves are provided substantially radially in each of the electromagnetic steel sheets constituting the rotor core and/or the electromagnetic steel sheets constituting the stator core.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a cross-sectional view (cross-sectional view along a radial direction of a rotor) illustrating a cooling structure of an electric motor according to an embodiment;

FIG. 2 is a cross-sectional view (cross-sectional view taken along an axial direction of the rotor) illustrating the cooling structure of the electric motor according to the embodiment;

FIG. 3 is a cross-sectional view (cross-sectional view taken along line III-III of FIG. 1) illustrating the cooling structure of the electric motor according to the embodiment;

FIG. 4 is a cross-sectional view (a cross-sectional view along the radial direction of the stator) illustrating the cooling structure of the electric motor according to the embodiment; and

FIG. 5 is a cross-sectional view (a cross-sectional view taken along the axial direction of the stator) illustrating the cooling structure of the electric motor according to the embodiment.

### DETAILED DESCRIPTION

With the cooling structure of the rotor for a rotary electrical machine described in JP-A No. 2013-183481, the axial central region of the rotor core can be efficiently cooled. However, in this cooling structure, it is difficult to uniformly cool the entire rotor, and the cooling performance (cooling efficiency) may be lowered.

The present disclosure has been made to solve the above problems, and it is desirable to provide a cooling structure of an electric motor capable of more uniformly cooling the electric motor and thus improving cooling performance (cooling efficiency).

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

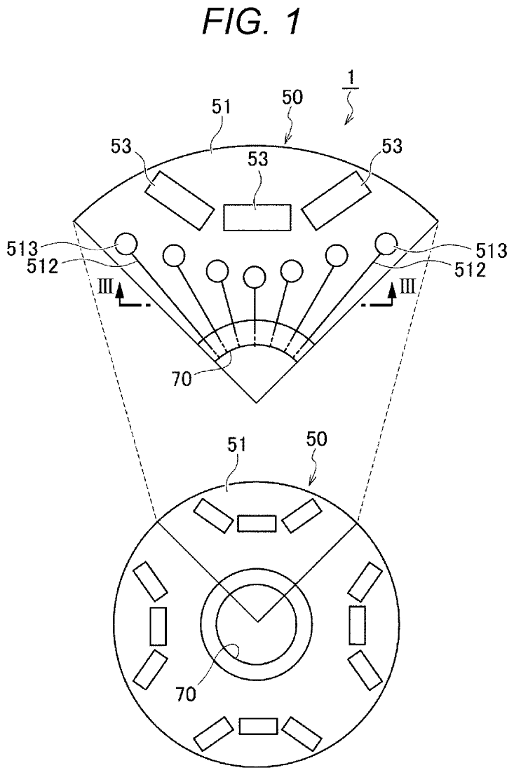

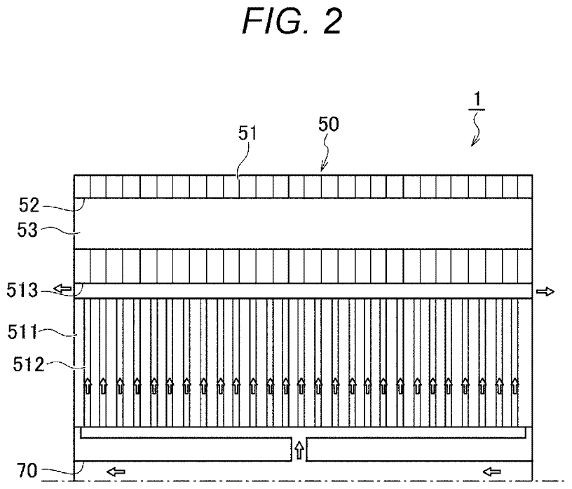

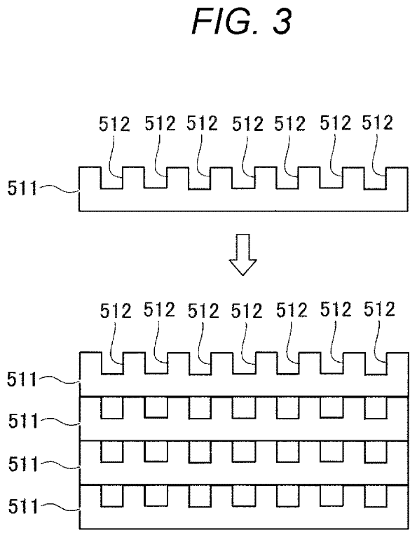

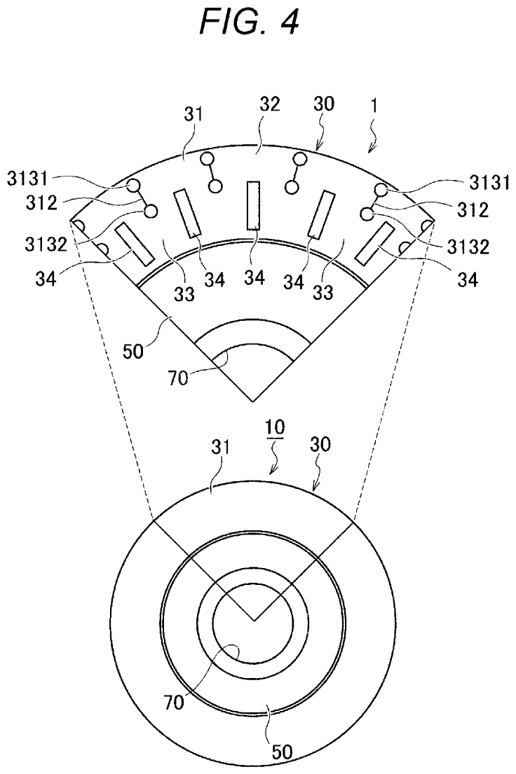

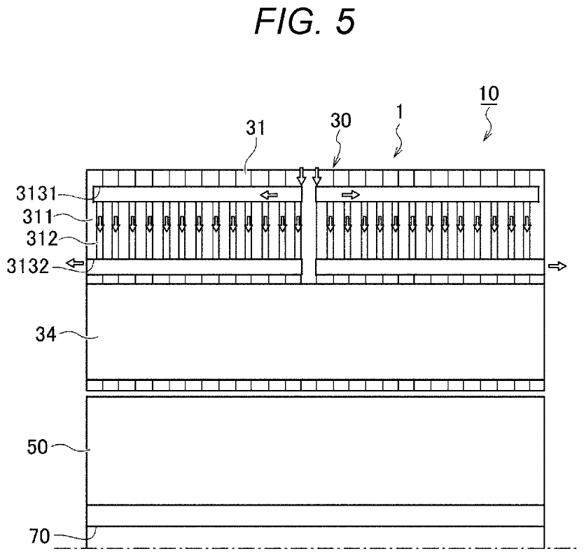

First, a configuration of a cooling structure 1 for an electric motor according to the embodiment will be described with reference to FIGS. 1 to 5. FIG. 1 is a cross-sectional view along a radial direction of a rotor 50 constituting an electric motor 10. FIG. 2 is a cross-sectional view taken along the axial direction of the rotor 50. FIG. 3 is a cross-sectional view taken along line III-III of FIG. 1. FIG. 4 is a cross-sectional view along a radial direction of a stator 30 constituting the electric motor 10. FIG. 5 is a cross-sectional view along the axial direction of the stator 30.

An electric motor 10 to which the cooling structure 1 for the electric motor is applied mainly includes a stator 30 including a stator core 31 having an annular cross section and coils 34 wound around the stator core 31, and a rotor 50 incorporating a permanent magnet 53 and rotatably disposed inside the stator 30. Note that, in the present embodiment, an interior permanent magnet (IPM) motor will be described as an example of the electric motor 10.

The stator 30 mainly includes an annular (cylindrical) stator core 31 having teeth 33, and stator windings (coils) 34 wound around the respective teeth 33.

For example, the stator core 31 has an annular shape (cylindrical shape) having stator segments (split cores) arranged in a circumferential direction of the stator 30. Each stator segment includes an arc-shaped yoke 32 extending in the circumferential direction of the stator core 31 and teeth 33 protruding radially inward of the stator core 31. In addition, each stator segment includes stacked electromagnetic steel sheets 311 having directivity, such as silicon steel sheets, for example.

With such a configuration, the teeth 33 extending radially inward are disposed at predetermined intervals along the circumferential direction in the stator core 31. The teeth 33 have a substantially rectangular (or circular) cross-sectional shape when cut along a plane orthogonal to the radial direction of the stator core 31 (the axis of the teeth 33).

A stator winding (coil) 34 is wound around a side surface of the teeth 33. The stator winding 34 includes a highly conductive wire, such as copper, coated with an insulating material, such as enamel.

The rotor 50 is disposed (arranged) inside the stator 30 and coaxially with the stator 30. The rotor 50 includes, for example, a steel sheet stack including stacked annular electromagnetic steel sheets 511. An output shaft 70 is fitted (for example, press-fitted) in the center of the rotor 50.

On the rotor 50, permanent magnets 53 are disposed (arranged) so as to be convexly curved (in an arc shape) toward a rotation axis side (inner side) when viewed from a rotation axis direction. Note that, in the present embodiment, three permanent magnets 53 are provided per pole. In the present embodiment, the number of poles of the electric motor 10 is four.

More specifically, the rotor 50 has a plurality of (12 in the present embodiment) magnet slots 52 having a rectangular cross section cut perpendicular to the rotation axis and extending in a columnar shape parallel to the rotation axis at intervals along the circumferential direction. Here, in the present embodiment, a configuration is adopted in which three magnet slots 52 disposed in an arc shape constitute one set (one pole), and magnet slots 52 of four poles in total, that is, magnet slots 52 of four poles (12 pieces) divided by 3 are provided.

A permanent magnet 53 is accommodated in each magnet slot 52. The permanent magnet 53 has, for example, a substantially rectangular plate shape, and is accommodated in each of the magnet slots 52.

As the permanent magnet 53, for example, a rare earth magnet is suitably used. Examples of the rare earth magnet include a three-component neodymium magnet in which iron and boron are added to neodymium, a samarium cobalt magnet including a two-component alloy of samarium and cobalt, and the like. Note that, in place of the rare earth magnet, a ferrite magnet using iron oxide powder as a main raw material, an alnico magnet using aluminum, nickel, cobalt, or the like as a raw material, or the like may be used.

Here, the electric motor 10 is cooled by, for example, a coolant such as oil (corresponding to a cooling medium described in the claims). For example, the electric motor cooling structure 1 can more uniformly cool the electric motor 10, and thus has a function of improving cooling performance (cooling efficiency).

Therefore, in each of the electromagnetic steel sheets 511 constituting a rotor core 51, recessed grooves 512 through which a coolant such as oil flows are formed substantially radially on one surface. That is, the rotor core 51 includes stacked electromagnetic steel sheets 511 in which recessed grooves 512 through which oil or the like flows are formed substantially radially on one surface.

The recessed grooves 512 can be formed by, for example, crushing (pressing) or the like. Here, in a case where the thickness of the electromagnetic steel sheets 511 is, for example, about 0.25 to 3 mm, it is preferable that each recessed groove 512 has a depth of, for example, about 0.1 mm and a width of 0.1 mm or more. Note that the size (depth and width) of the recessed groove 512 is preferably set in consideration of pressure loss of a coolant such as oil.

Through holes 513 penetrating in the axial direction are formed in the rotor core 51.

Each of the through holes 513 is coupled to (communicates with) an end of each of the recessed grooves 512 overlapping each other when viewed from the axial direction among the recessed grooves 512. Thus, the recessed grooves 512 are disposed (formed) between the inner peripheral surface (output shaft 70) of the rotor 50 and the through hole 513. Each of the through holes 513 collects a coolant such as oil flowing from each of the recessed grooves 512 and discharges the coolant from both side surfaces of the rotor core 51 to the outside.

Note that, in order to supply (distribute) oil or the like from the inside (shaft center) of the output shaft 70 to each of the recessed grooves 512, for example, a groove is formed on an outer peripheral surface (excluding both ends) of the output shaft 70 so as to face an opening end of the recessed groove 512 along the axial direction, and a through hole is formed to penetrate a bottom portion of the groove and the hollow shaft center in the radial direction.

Further, in order to avoid division of a magnetic circuit by the through hole 513 penetrating in the axial direction and suppress deterioration of torque characteristics and the like, each of the through holes 513 (and the recessed grooves 512) is disposed (formed) avoiding the magnetic circuit through which the magnetic flux passes (easily passes). For example, the through holes 513 (and the recessed grooves 512) are, for example, disposed inside the permanent magnet 53 and curved in a convex shape toward the rotation axis side (inside) when viewed from the rotation axis direction.

In each of the electromagnetic steel sheets 311 constituting the stator core 31, recessed grooves 312 through which a coolant such as oil flows are also formed substantially radially on one surface. That is, the stator core 31 includes stacked electromagnetic steel sheets 311 in which the recessed grooves 312 through which oil or the like flows are formed substantially radially on one surface.

Similarly to the rotor core 51 described above, the recessed grooves 312 can be formed by, for example, crushing (pressing) or the like. Here, in a case where the thickness of the electromagnetic steel sheet 311 is, for example, about 0.25 to 3 mm, it is preferable that each recessed groove 312 has, for example, a depth of about 0.1 mm and a width of 0.1 mm or more. Note that the size (depth and width) of the recessed groove 312 is preferably set in consideration of pressure loss of a coolant such as oil.

Further, through holes penetrating in the axial direction, that is, outer peripheral side through holes (distribution holes) 3131 and inner peripheral side through holes 3132 are formed in the stator core 31. When viewed from the rotation axis direction, each of the outer peripheral side through holes (distribution holes) 3131 is disposed radially outward, and each of the inner peripheral side through holes 3132 is disposed radially inward. Further, the outer peripheral side through holes (distribution hole) 3131 and the inner peripheral side through holes 3132 are disposed in pairs.

The outer peripheral side through hole (distribution hole) 3131 is coupled (communicated) to one end of each of the recessed grooves 312 overlapping as viewed in the axial direction among the recessed grooves 312, and the inner peripheral side through hole 3132 is coupled (communicated) to the other end of each of the recessed grooves 312 overlapping as viewed in the axial direction among the recessed grooves 312. Thus, the recessed grooves 312 are disposed (formed) between the outer peripheral side through hole (distribution hole) 3131 and the inner peripheral side through hole 3132.

The outer peripheral side through hole (distribution hole) 3131 is, for example, divided (divided into two) at substantially the center, and both ends are closed. The outer peripheral side through hole (distribution hole) 3131 distributes, for example, a coolant such as oil supplied from the outside of the stator 30 to each of the recessed grooves 312.

The inner peripheral side through hole 3132 is, for example, divided (divided into two) at substantially the center, and both ends are open. For example, the inner peripheral side through hole 3132 collects a coolant such as oil flowing from each of the recessed grooves 312 and discharges the coolant from both side surfaces of the stator 30 (stator core 31) to the outside.

In addition, in order to avoid division of the magnetic circuit by the outer peripheral side through hole (distribution hole) 3131 and the inner peripheral side through hole 3132 penetrating in the axial direction and to suppress deterioration of torque characteristics and the like, each of the outer peripheral side through holes (distribution holes) 3131 and each of the inner peripheral side through holes 3132 (and the recessed grooves 312) are disposed (formed) avoiding the magnetic circuit through which the magnetic flux passes (easily passes). For example, each of the outer peripheral side through holes (distribution holes) 3131 and each of the inner peripheral side through holes 3132 (and the recessed grooves 312) are disposed (formed) between the stator winding (coil) 34 and the stator winding (coil) 34 adjacent to each other and are disposed to be offset toward the outer peripheral side when viewed from the axial direction.

The rotor 50 is configured (the flow path (oil path) of oil or the like is formed) as described above, that is, the rotor core 51 includes the stacked electromagnetic steel sheets 511 in which the recessed grooves 512 through which oil or the like flows are formed substantially radially on one surface, and the end of each of recessed grooves 512 overlapping as viewed in the axial direction among the recessed grooves 512 is coupled to the through hole 513 penetrating in the axial direction. Thus, for example, oil or the like supplied through the inside (shaft core) of the output shaft 70 flows from the output shaft 70 into the recessed grooves 512, and passes through the recessed grooves 512 (by hydraulic pressure or centrifugal force due to rotation of the rotor 50) to be sent to the respective through holes 513 arranged on the outer peripheral side.

Then, they are collected in the through holes 513 and discharged to the outside from both side surfaces of the rotor 50.

Since the coolant such as oil flows in this manner, the area (contact area) where the oil flows, that is, the cooling area of the rotor 50 (rotor core 51) is enlarged, and the rotor core 51 and the permanent magnet 53 are more uniformly and more efficiently cooled.

In addition, the stator 30 is configured (the flow path (oil path) of oil or the like is formed) as described above, that is, the stator core 31 includes the stacked electromagnetic steel sheets 311 in which the recessed grooves 312 through which oil or the like flows are formed substantially radially on one surface, and one end of each of recessed grooves 312 overlapping as viewed in the axial direction among the recessed grooves 312 is coupled to the outer peripheral side through hole (distribution hole) 3131 and the other end is coupled to the inner peripheral side through hole 3132. Thus, for example, oil or the like supplied from the outer periphery of the stator 30 flows from the outer periphery of the stator 30 into the outer peripheral side through holes (distribution hole) 3131, is distributed by the outer peripheral side through holes (distribution holes) 3131 to the respective recessed grooves 312, and is sent to the inner peripheral side through holes 3132 through the recessed grooves 312. Then, the oil is collected by the inner peripheral side through holes 3132 and discharged to the outside from both side surfaces of the stator 30.

Since the coolant such as oil flows in this manner, the area (contact area) where the oil flows, that is, the cooling area of the stator 30 (stator core 31) is enlarged, and the stator core 31 and the stator winding 34 are more uniformly and more efficiently cooled.

As described above in detail, according to the present embodiment, the rotor core 51 includes the stacked electromagnetic steel sheets 511 in which the recessed grooves 512 through which oil or the like flows are formed substantially radially on one surface. Thus, the area (contact area) through which the oil or the like flows, that is, the cooling area of the rotor core 51 can be enlarged. Therefore, the rotor core 51 can be cooled more uniformly and more efficiently. In addition, the stator core 31 includes the stacked electromagnetic steel sheets 311 in which the recessed grooves 312 through which oil or the like flows are formed substantially radially on one surface. Thus, the area (contact area) through which the oil or the like flows, that is, the cooling area of the stator core 31 can be enlarged. Therefore, the stator core 31 can be cooled more uniformly and more efficiently.

As a result, the electric motor 10 can be more uniformly cooled (that is, cooling with less unevenness in temperature distribution is implemented), and thus the cooling performance (cooling efficiency) can be improved.

In addition, since the permanent magnet 53 of the rotor 50 can be efficiently cooled, the operating temperature range of the permanent magnet 53 can be lowered. As a result, it is possible to increase the output of the electric motor 10, or it is possible to use a permanent magnet of a lower heat resistance grade in a case where the output is equivalent, and thus, it is possible to reduce the cost of the electric motor 10. Furthermore, since the stator windings (coils) 34 of the stator 30 can be efficiently cooled, the use temperature of the stator windings (coils) 34 is lowered, whereby the copper loss of the electric motor 10 is reduced, and the electric cost can be improved.

According to the present embodiment, the through holes (the outer peripheral side through holes (distribution holes) 3131, the inner peripheral side through holes 3132, and the through holes 513) are formed so as to penetrate in the axial direction, are coupled to ends of the recessed grooves 312 and 512 overlapping with each other when viewed from the axial direction among the recessed grooves 312 and 512, and distribute oil or the like to the recessed grooves 312 and 512, respectively, or collects and discharges oil or the like from the recessed grooves 312 and 512, respectively. Therefore, a coolant such as oil can be efficiently supplied to and discharged from each of the recessed grooves 312 and 512.

According to the present embodiment, the outer peripheral side through holes (distribution holes) 3131, the inner peripheral side through holes 3132, and the through holes 513 (and the recessed grooves 312 and 512) are disposed (formed) avoiding the magnetic circuit through which the magnetic flux passes (easily passes). Therefore, it is possible to avoid division of the magnetic circuit due to the through holes or the like, and it is possible to suppress deterioration of torque characteristics or the like. For example, by forming the recessed grooves 312 and 512 by crushing processing (press processing), the degree of freedom in shape of the recessed grooves 312 and 512 (oil paths) can be increased, so that it is possible to more flexibly avoid the magnetic circuit while securing cooling performance.

According to the present embodiment, for example, the through holes 513 (and the recessed grooves 512) are disposed inside the permanent magnet 53 and convexly curved toward the rotation axis side (inside) when viewed from the rotation axis direction. Further, each of the outer peripheral side through holes (distribution holes) 3131 and each of the inner peripheral side through holes 3132 (and the recessed grooves 312) are disposed (formed) between the adjacent stator windings 34 and 34 and are disposed to be offset toward the outer peripheral side when viewed from the axial direction. Therefore, it is possible to avoid division of the magnetic circuit by each of the outer peripheral side through holes (distribution holes) 3131, each of the inner peripheral side through holes 3132, and the like, and deterioration of torque characteristics and the like can be suppressed.

Although the embodiments of the present disclosure have been described above, the present disclosure is not limited to the above embodiments, and various modifications can be made. For example, in the above embodiment, the electromagnetic steel sheets 311 and 511 are stacked so that one surface on which the recessed grooves 312 and 512 are formed and the other surface on which the recessed grooves 312 and 512 are not formed face each other. However, the electromagnetic steel sheets 311 and 511 may be stacked so that one surface and one surface face each other and the other surface and the other surface face each other.

Furthermore, for example, the number, shape, size, and the like of the recessed grooves 312 and 512 to be formed may be changed according to temperature distribution and the like. That is, for example, in the portion where the temperature is relatively high, the number of the recessed grooves 312 and 512 may be increased or the size may be increased as compared with the portion where the temperature is low. Furthermore, for example, the shapes and the like of the recessed grooves 312 and 512 may be changed according to the magnetic circuit so as to avoid the magnetic circuit.

In addition, the arrangement, the number, the number of poles, and the like of the permanent magnets 53 attached to the rotor 50 described in the above embodiment are merely examples, and the disclosure is not limited to the above embodiment. In the above embodiment, the case where the present disclosure is applied to an interior permanent magnet (IPM) motor has been described as an example, but the present disclosure can also be applied to other types of electric motors such as a surface permanent magnet (SPM) motor and an induction motor (IM motor).

Furthermore, dimensions, materials (materials), other specific numerical values, and the like illustrated in the above embodiments are examples for facilitating understanding of the present disclosure, and do not limit the present disclosure unless otherwise specified.

In the cooling structure of the electric motor according to the aspect of the present disclosure, a rotor core and/or a stator core includes stacked electromagnetic steel sheets in which recessed grooves through which a cooling medium flows are formed substantially radially. Thus, it is possible to increase an area (contact area) through which the cooling medium flows, that is, a cooling area of the rotor core and/or the stator core. Therefore, the rotor core and/or the stator core can be cooled more uniformly and more efficiently.

According to the present disclosure, it is possible to more uniformly cool the electric motor, thereby improving cooling performance (cooling efficiency).

1. A cooling structure of an electric motor, the cooling structure comprising:
a rotor core including stacked electromagnetic steel sheets; and
a stator core including stacked electromagnetic steel sheets, wherein
recessed grooves that allow a cooling medium to flow through the recessed grooves are provided substantially radially in each of the electromagnetic steel sheets constituting the rotor core and/or the electromagnetic steel sheets constituting the stator core.

2. The cooling structure of the electric motor according to claim 1, wherein the recessed grooves are provided on one surface of each of the electromagnetic steel sheets constituting the rotor core and/or the electromagnetic steel sheets constituting the stator core.

3. The cooling structure of the electric motor according to claim 2, further comprising through holes provided so as to penetrate in an axial direction, and coupled to respective ends of ones of the recessed grooves, the ones overlapping with each other as viewed in the axial direction, the through holes distributing a cooling medium to each of the ones of the recessed grooves or collecting and discharging the cooling medium from each of the ones of the recessed grooves.

4. The cooling structure of the electric motor according to claim 3, wherein the through holes and the ones of the recessed grooves are disposed so as to avoid a magnetic circuit through which a magnetic flux passes.

5. The electric motor cooling structure according to claim 4, wherein the through holes and the ones of the recessed grooves are disposed between a stator winding and a stator winding when viewed from the axial direction.
